(19) United States
(12) Patent Application Publication
(10) Pub. No.: US 2004/0267919 A1
(43) Pub. Date: Dec. 30, 2004

(54) Method and system for providing server management peripheral caching using a shared bus

(75) Inventors: Gregory W. Dake, Durham, NC (US); James A. Day JR., Durham, NC (US); Brandon J. Ellison, Raleigh, NC (US); Eric R. Kern, Durham, NC (US); Shane M. Lardinois, Durham, NC (US); Howard J. Locker, Cary, NC (US)

Correspondence Address: SAWYER LAW GROUP LLP, PO BOX 51418, PALO ALTO, CA, 94303, US

(73) Assignee: International Business Machines Corporation, Armonk, NY

(21) Appl. No.: 10/610,244

(22) Filed: Jun. 30, 2003

(51) Int. Cl. G06F 15/173

(52) U.S. Cl. 709/223

(57) ABSTRACT

A method and system for managing a computer system including a plurality of servers and at least one shared peripheral device is disclosed. The method and system include performing communications between the plurality of servers and the at least one shared peripheral device using a shared bus. The communications include providing data for a first server of the plurality of servers from the shared peripheral device(s). The data is provided to the servers over the shared bus. The method and system also include caching the data in the plurality of servers and utilizing the data only in the first server in response to receipt of the data.

### FIELD OF THE INVENTION

The present invention relates to computer systems, and more particularly to a method and system for managing a shared peripheral for multiple servers using a shared bus.

### BACKGROUND OF THE INVENTION

Computer systems can include multiple servers, typically in the form of blades. The multiple servers are often controlled using a single management controller. In addition, the servers share one or more shared peripheral devices, such as a CD-ROM or floppy drive. Consequently, the servers' access to data on the shared peripheral device must be managed.

FIG. 1 depicts a conventional method 10 for allowing the servers to communicate with a shared peripheral device. The method 10 is typically used for each of the peripheral devices that the servers share. One of the servers establishes a connection to the shared peripheral device, via step 12. The particular server connected to the shared peripheral device provides a request to the shared peripheral device, via step 14. For example, the particular server may request data to be provided from the shared peripheral device or may write to the shared peripheral device. The data is sent from the shared peripheral device to the particular server that requested the data, via step 16. Thus, in step 16, one or more data packets are sent to the particular server from the shared peripheral device. Once the desired data has been received by the particular server, the particular server disconnects from the shared peripheral device, via step 18. Once the particular server disconnects from the shared peripheral device, the shared peripheral device can be accessed by other servers in the computer system.

Although the conventional method 10 allows servers to communicate with a shared peripheral device, one of ordinary skill in the art will readily recognize that more than one of the servers may desire access to the same data. For example, an update of the servers is typically performed by the system administrator one server at a time. However, the same data from the shared peripheral device is typically used for each of the servers. Consequently, each of the servers must receive a new copy of the data when the server is being updated. The use of the shared peripheral device may, therefore, be inefficient.

Accordingly, what is needed is a system and method for more efficiently managing the communication between the servers and shared peripheral devices. The present invention addresses such a need.

### SUMMARY OF THE INVENTION

A method and system for managing a computer system including a plurality of servers and at least one shared peripheral device is disclosed. The method and system include performing communications between the plurality of servers and the at least one shared peripheral device using a shared bus. The communications include providing data for a first server of the plurality of servers from the shared peripheral device(s). The data is provided to the servers over the shared bus. The method and system also include caching the data in the plurality of servers and utilizing the data only in the first server in response to receipt of the data.

According to the system and method disclosed herein, the present invention provides a more efficient method and system for accessing data on a shared peripheral device using a shared bus.

### BRIEF DESCRIPTION OF THE DRAWINGS

FIG. 1 is a flow chart depicting a conventional method for accessing data in a shared peripheral device.

FIG. 2 is a block diagram depicting one embodiment of a computer system in accordance with the present invention that more efficiently manages the interaction between the servers and the shared peripheral device.

FIG. 3 is a block diagram depicting a preferred embodiment of a computer system in accordance with the present invention that more efficiently manages the interaction between the servers and the shared peripheral device.

FIG. 4 is a high-level flow chart depicting one embodiment of a method for more efficiently managing the communication between the servers and the shared peripheral device.

FIG. 5 is a more detailed flow chart depicting a preferred embodiment of a method for more efficiently managing the communication between the servers and the shared peripheral device.

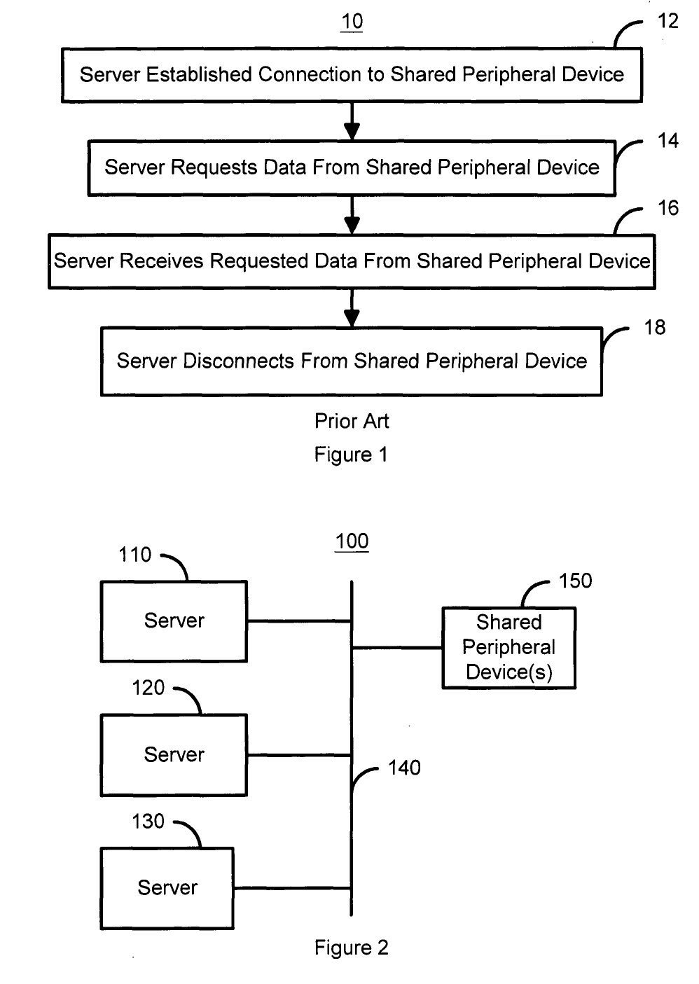

### DETAILED DESCRIPTION OF THE INVENTION

The present invention relates to an improvement in computer system. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

A method and system for managing a computer system including a plurality of servers and at least one shared peripheral device is disclosed. The method and system include performing communications between the plurality of servers and the at least one shared peripheral device using a shared bus. The communications include providing data for a first server of the plurality of servers from the shared peripheral device(s). The data is provided to the servers over the shared bus. The method and system also include caching the data in the plurality of servers and utilizing the data only in the first server in response to receipt of the data.

The present invention will be described in the context of particular computer systems. However, one of ordinary skill in the art will readily recognize that this method and system will operate effectively for other computer system and other and/or additional components. Furthermore, the present invention is described in terms of methods having certain steps. However, one of ordinary skill in the art will readily recognize that the method and system function effectively for other methods having different and/or additional steps. Moreover the method and system is described in the context of a single shared peripheral device. However, one of ordinary skill in the art will readily recognize that the method and system are consistent with the use of multiple shared peripheral devices.

To more particularly illustrate the method and system in accordance with the present invention, refer now to FIG. 2, depicting one embodiment of a computer system 100 in accordance with the present invention that more efficiently manages the interaction between the servers and the shared peripheral device. The computer system 100 includes servers 110, 120, and 130, a shared peripheral device 150, and a shared bus 140. Although one shared peripheral device 150 is depicted, nothing prevents the use of multiple shared peripheral devices (not shown), preferably coupled to the shared bus in a manner analogous to the shared peripheral device 150. Furthermore, although three servers 110, 120, and 130 are shown, nothing prevents the use of another number of servers.

The servers 110, 120, and 130 are connected to and share the peripheral device 150 via the shared bus 140. In a preferred embodiment, described below, the shared bus 140 is a system management bus. The servers 110, 120, and 130 communicate with the shared peripheral device 150 over the shared bus 140. Thus, when one server 110, 120, or 130 receives data from the shared peripheral device 150, the data is broadcast to all of the servers 110, 120, and 130 via the shared bus 140. As a result, the servers 110, 120, and 130 could all receive and cache data sent to one of the servers 110, 120 or 130 from the shared peripheral device 15. For example, the server 10 might provide a request to the shared peripheral device 150, the response to which includes data to be provided to the server 110. The data is provided over the shared bus 140. Consequently, all of the servers 1110, 120, and 130 snoop and could cache the data. The server 110 for which the data is meant can use the data upon receipt of the data. However, the remaining servers 120 and 130 preferably only cache the data. If the remaining servers 120 and 130 subsequently desire some portion of the data, the serves 120 and 130 can use the previously cached data. Consequently, multiple copies of the data may not need to be sent from the shared peripheral device 150, thereby improving the efficiency of use of the shared peripheral device 150.

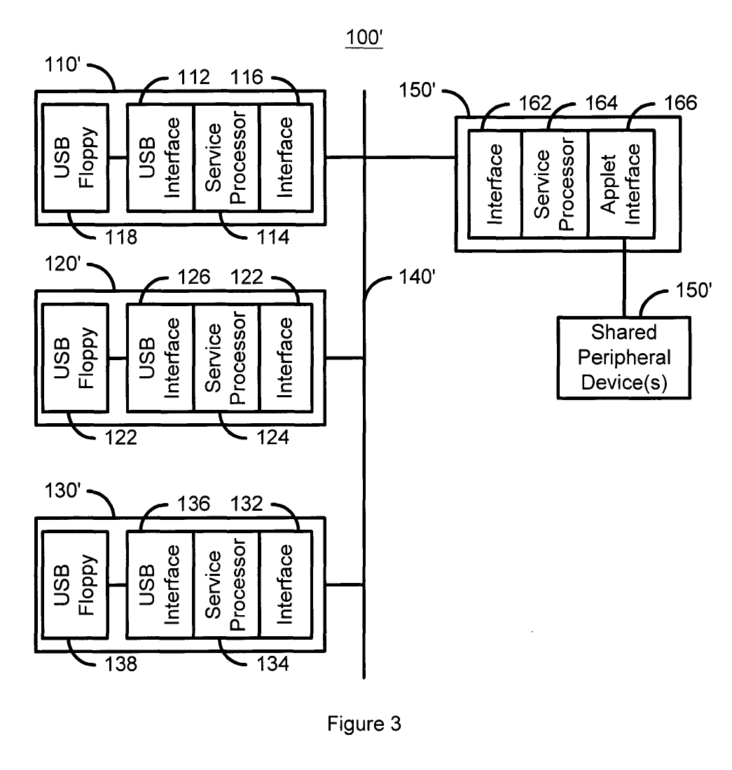

FIG. 3 is a block diagram depicting a preferred embodiment of a computer system 100′ in accordance with the present invention that more efficiently manages the interaction between the servers and the shared peripheral device. The computer system 100′ includes many of the same components as the computer system 100. Consequently, such components are labeled similarly.

The computer system 100′ includes servers 110′, 120′, and 130′, a shared peripheral device 150′, a shared bus 140′ and a system management controller 160. Although one shared peripheral device 150′ is depicted, nothing prevents the use of multiple shared peripheral devices (not shown), preferably coupled to the shared bus in a manner analogous to the shared peripheral device 150′. Furthermore, although three servers 110′, 120′, and 130′ are shown, nothing prevents the use of another number of servers.

The servers 110′, 120′, and 130′ are preferably substantially the same. The server 110′ includes a system management processor having an USB interface 112, a service processor 114, and an interface 116 to the shared bus 140′. The server 110′ also preferably includes a USB floppy 118 coupled to the USB interface 112. Similarly, the server 120′ preferably includes an USB interface 122, a service processor 124, an interface 126 and an USB floppy 128. The server 130′ preferably includes an USB interface 132, a service processor 134, an interface 136 and an USB floppy 138. The interfaces 116, 126, and 136 are preferably broadcast network interfaces. However, nothing prevents the use of other and/or different constituents to each server 110′, 120′, and 130′. The shared bus 140′ is preferably an R485 bus for a broadcast network.

The system management controller 160 includes an interface 162 to the shared bus 140, a service processor 164, and an applet interface 166. The system management controller 160 is coupled to the shared peripheral device 150 through the applet interface 166. Thus, the system management controller 160 can be used to exert additional control over the communication between the servers 110′, 120′, and 130′ and the shared peripheral device 150′. For example, the system management controller 160 could block access from one or more of the servers 110′, 120′, and 130′ to the shared peripheral device 150 or provide exclusive access to the shared peripheral device 150, depending upon the circumstances.

When one server 110′, 120′, or 130′ receives data from the shared peripheral device 150′, the data is broadcast over the shared bus 140′. All of the servers 110′, 120′, and 130′ could thus snoop the data on the shared bus 140′. The servers 110′, 120′, and 130′ could all receive and cache data sent to one of the servers 110′, 120′ or 130′ from the shared peripheral device 150′. The server 110′, 120′, or 130′ for which the data is meant can use the data upon receipt of the data. However, the remaining servers 110′, 120′ and/or 130′ can cache the data. Thus, if the servers 120′ and 130′ subsequently desire some portion of the data, the serves 120′ and 130′ can use the previously cached data.

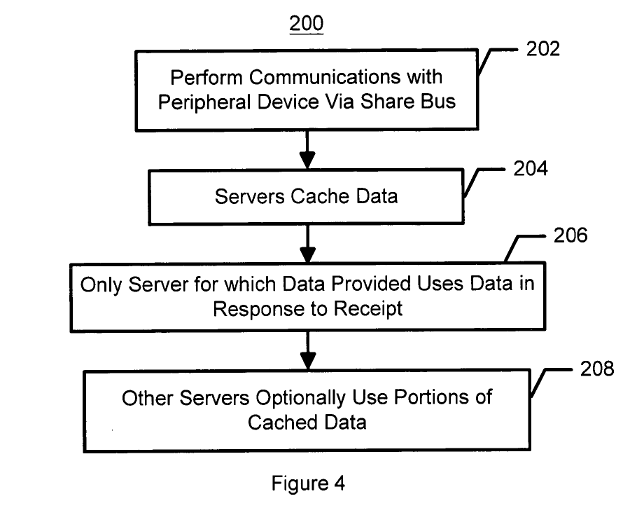

FIG. 4 is a high-level flow chart depicting a method 200 for more efficiently managing the communication between the servers and the shared peripheral device. The method 200 is described in the context of the computer system 100′. However, nothing prevents the use of the method 200 in another computer system.

Communications between the servers 110′, 120′, and 130′ and the shared peripheral device 150′ are performed using the shared bus 140′, via step 202. Thus, data for a particular one of the servers 110′, 120′, or 130′ from the shared peripheral device 150′ is broadcast over the shared bus 140′. Because the data is broadcast over the shared bus 140, the servers 110′, 120′, and 130′ could all receive the data. For example, the server 110′ may be being updated. Thus, data for the update of the server 110′ is broadcast over the shared bus 140 in step 202. Because the shared bus 202 is used, the servers 120′ and 130′ also have access to the data.

One or more of the servers 110′, 120′, and 130′ caches the data, via step 204. In a preferred embodiment, it is known in advance whether the servers 110′, 120′, and 130′ will be using the data that has been broadcast. Consequently, only those servers 110′, 120′, and/or 130′ that will use the data will cache the data in step 204. For example, as discussed above, the server 110′ may be in the process of being updated. Consequently, data for the server 110′ may be provided over the shared bus 140′. It may also be known that the servers 120′ and 130′ are to be updated. In such a case, the servers 120′ and 130′ would also cache the data for the update. However, in an alternate embodiment, all of the servers 110′, 120′, and 130′ may cache the data in step 204.

Only the server 110′, 120′ or 130′ for which the data is actually provided would use the data only in response to receipt of the data, via step 206. Thus, in the example above, only the server 110′ would actually use the data in an update in response to receiving the data. The servers 120′ and 130′ would merely cache the data. The remaining server(s) could subsequently use some portion of the cached data when desired, via step 208. The remaining server(s) might use all of the cached data or only part of it in step 208. In addition, the data is only used if the data has not been purged from the cache of the server 110′, 120′ or 130′. In the example above, the data that has already been cached in the servers 120′ and 130′ would be used in the servers 120′ and 130′, respectively, when the servers 120′ and 130′ are updated.

Thus, using the method 200, data provided for one of the servers 110, 120′, or 130′ is also cached by other servers' 110′, 120′ or 130′ use. This cached data is available for these servers subsequent use. If the other servers use some portion of this data, it need not be provided from the shared peripheral device 140′ again. Consequently, use of the shared peripheral device 140′ is made more efficient.

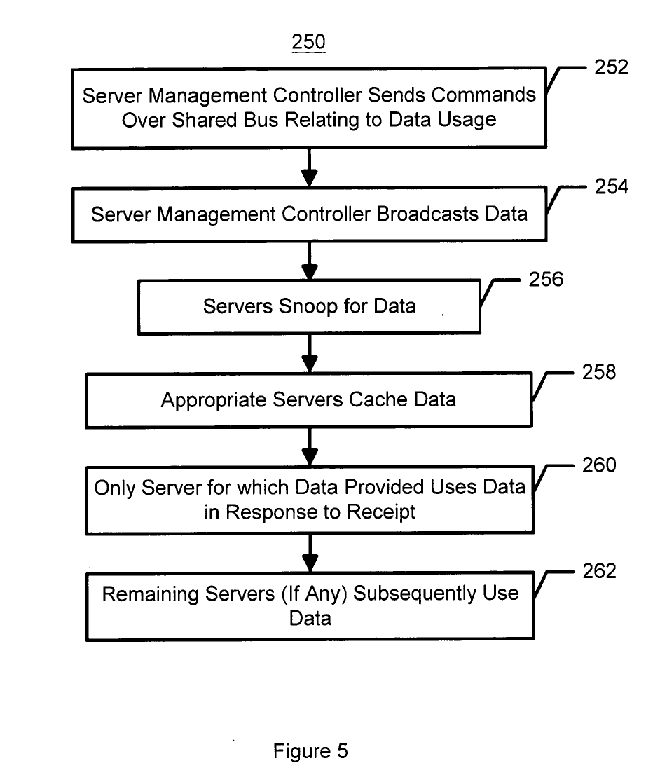

FIG. 5 is a more detailed flow chart depicting a preferred embodiment of a method 250 for more efficiently managing the communication between the servers and the shared peripheral device. The method 250 is described in the context of the system 100′. However, nothing prevents the method 250 from being used in another system. The method 250 commences when data is to be provided to one of the servers 110′, 120′, or 130′. For example, the method 250 commences when one of the servers 110′, 120′, or 130′ has requested data from the shared peripheral device 150′.

The system management controller 160′ sends commands to the servers 110′, 120′, and 130′, via step 252. The commands indicate whether each server 110′, 120′ and/or 130′ is to use data that will be provided from the shared peripheral 150′. For example, the commands could include the address of each server 110′, 120′, and/or 130′ that will use the data and a hash signature identifying the data. The servers 110′, 120′, and 130′ that are to use the data are not limited to the server 110′, 120′ and 130′ that actually requested the data. Instead, information relating to the task being performed, such as an update, can be used to determine which additional servers 110′, 120′, and/or 130′ are to use the data. The system management controller 160′ then sends the data over the shared bus 140′, via step 254. The appropriate servers 110′, 120′, and/or 130′ snoop for the data, via step 256. In a preferred embodiment, only those servers 110′, 120′ and/or 130′ informed in step 252 that they are to use the data snoop for the data in step 256. The data is cached in the appropriate servers 110′, 120′, and/or 130′, via step 258. Thus, data for one server 110′, 120′, or 130′ may be cached in multiple servers 110′, 120′, and/or 130′. The server for which the data is sent then uses the data, via step 260. In a preferred embodiment, step 260 includes the server 110′, 120′, or 130′ receiving an additional command indicating that the data can be used. The remaining servers (if any) subsequently use the cached data, via step 262. Step 262 preferably includes each remaining server receiving a command from the system management controller 160′ indicating that the cached data is to be used. Step 262 also preferably includes each remaining server using the data in response to the command.

Thus, using the method 250, efficiency of data transfer from the shared peripheral device 150′ is improved because all servers 110′, 120′, and/or 130′ that are to use the data cache the data. The data need not be separately sent from the shared peripheral device 150 to each server 110′, 120′, and 130′. Furthermore, the servers 110′, 120′, and/or 130′ that will not use the data do not cache the data. Consequently, using the method 250, the servers 110′, 120′, and 130′ do not unnecessarily cache data. Efficiency of the use of the shared peripheral 150′ is, therefore, further improved.

A method and system has been disclosed for managing communication between servers and shared peripheral devices through a shared bus. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for managing a computer system including a plurality of servers and at least one shared peripheral device comprising the steps of:
performing communications between the plurality of servers and the at least one shared peripheral device using a shared bus, the communications including providing data for a first server of the plurality of servers from the at least one shared peripheral device, the data being provided to the plurality of servers over the shared bus,
caching the data in the plurality of servers; and
utilizing the data only in the first server in response to receipt of the data.

2. The method of claim 1 further comprising the steps of:
subsequently utilizing at least a portion of the data in a second server of the plurality of servers if the second server is to use the at least the portion of the data and if the at least the portion of the data still resides in a cache for the second server.

3. The method of claim 1 wherein the computer system further includes a server management controller coupled to the shared bus, the server management module being coupled between at least one peripheral being and the shared bus, wherein the communication performing step further includes the steps of:
providing a first command to the plurality of servers, the first command indicating the data and whether each of the plurality of servers is to use the data.

4. The method of claim 3 wherein the caching step further includes the steps of:
snooping the shared bus using each of the plurality of servers.

5. The method of claim 4 caching step further includes the steps of:
caching the data in each of the plurality of servers that is to use the data.

6. The method of claim 1 wherein the at least the portion of the data utilizing step further includes the steps of:
receiving a second command in the second server, the second command indicating that the at least the portion of the data is to be used by the second server.

7. The method of claim 1 wherein the computer system includes a server management controller and wherein the shared bus is a system management bus.

8. The method of claim 6 wherein the server management controller includes at least one applet interface for coupling with the at least one peripheral.

9. A computer system comprising:
a plurality of servers;
a shared bus coupled with the plurality of servers; and
at least one shared peripheral device coupled with the shared bus, communications between the plurality of servers and the at least one shared peripheral device being performed using the shared bus, the communications including one providing data for a first server of the plurality of servers from the at least one shared peripheral device, the data being provided to the plurality of servers over the shared bus, the data being cached in the plurality of servers, the data only being utilized in the first server in response to receipt of the data.

10. The computer system of claim 9 wherein a second server of the plurality of servers subsequently utilizes at least a portion of the data if the second server is to use the at least the portion of the data and if the at least the portion of the data still resides in a cache for the second server.

11. The computer system of claim 9 further comprising:
a server management controller coupled to the shared bus, the server management controller being coupled between at least one peripheral being and the shared bus, wherein the server management controller provides a first command to the plurality of servers, the first command indicating the data and whether each of the plurality of servers is to use the data.

12. The computer system of claim 11 wherein each of the plurality of servers is configured to snoop the shared bus.

13. The computer system of claim 12 wherein each of the plurality of servers that is to use the data caches the data.

14. The computer system of claim 9 wherein the second server is configured to receive a second command, the second command indicating that the at least the portion of the data is to be used by the second server.

15. The computer system of claim 1 further comprising:
a server management controller and wherein the shared bus is a server management controller.

16. The computer system of claim 14 wherein the server management controller includes at least one applet interface for coupling with the at least one peripheral.

17. The computer system of claim 9 further comprising:
a second plurality of servers.
